(19) United States
(12) Patent Application Publication
(10) Pub. No.: US 2019/0196494 A1
(43) Pub. Date: Jun. 27, 2019

(54) AUTONOMOUS DRIVING SYSTEM AND AUTONOMOUS DRIVING METHOD

(71) Applicant: Toyota Jidosha Kabushiki Kaisha, Toyota-shi Aichi-ken (JP)

(72) Inventors: Isao Kanehara, Miyoshi-shi Aichi-ken (JP); Kazuhiro Umeda, Nisshin-shi Aichi-ken (JP); Hideo Hasegawa, Nagoya-shi Aichi-ken (JP); Tsuyoshi Okada, Toyota-shi Aichi-ken (JP); Shinjiro Nagasaki, Minato-ku Tokyo (JP)

(21) Appl. No.: 16/226,129

(22) Filed: Dec. 19, 2018

(30) Foreign Application Priority Data
Dec. 27, 2017 (JP) 2017-252151

(51) Int. Cl. G05D 1/02; G05D 1/00; H04N 7/18; G06K 9/00

(52) U.S. Cl. CPC G05D 1/0246; G05D 1/0088; G05D 2201/0209; H04N 7/181; G06K 9/00369; G05D 1/0297

(57) ABSTRACT

A system performs crime prevention activities using mobile objects efficiently. The system includes an acquisitioner provided in each of a plurality of mobile objects and configured to acquire information about surroundings of the mobile object when the mobile object is moving, and a controller configured to determine a patrol plan for each of a plurality of regions on the basis of the information acquired by the acquisitioner of some mobile objects among the plurality of mobile objects that have moved in the same region, and create an operation command according to the patrol plan for each region determined by the controller.

### CROSS REFERENCE TO RELATED APPLICATION

This application claims priority to Japanese Patent Application No. 2017-252151, filed on Dec. 27, 2017, which is hereby incorporated by reference herein in its entirety.

### BACKGROUND

### Technical Field

The present disclosure relates to an autonomous driving system and an autonomous driving method.

### Description of the Related Art

There have been developed autonomous mobile objects that can run autonomously without driving operations by a human driver. For example. Patent Literature 1 describes transporting a user or goods to a destination by a first mobile object and a second mobile object that cooperates with the first mobile object when the first mobile object becomes inoperative while transporting the user or goods. Patent Literature 1 also discloses employing a mobile object for crime prevention activities in a certain region by creating an operation command that causes the mobile object to patrol that region in a time period (e.g. night time) in which the use of mobile objects is low.

### CITATION LIST

### Patent Literature

Patent Literature 1: Japanese Patent Application Laid-Open No. 2015-092320

### SUMMARY

In the case of the crime prevention system using mobile objects described in Patent Literature 1, a mobile object receives instructions prepared according to the time, region, and/or other factors. However, such instructions are not instructions suited to actual circumstances at that time but predetermined instructions that have been prepared in advance. If the entire system can perform crime prevention activities utilizing information acquired by a plurality of mobile objects, efficient crime prevention activities can be realized. Thus, existing technologies pertaining to patrol of a certain region needs improving.

The present disclosure has been made under the above circumstances, and an object of the present disclosure is to enable crime prevention activities using mobile objects to be performed efficiently.

According to one aspect of the present disclosure, there is provided an autonomous driving system including a plurality of mobile objects that perform a patrol autonomously on the basis of an operation command, comprising an acquisitioner provided in each of said plurality of mobile objects and configured to acquire information about surroundings of said mobile object when said mobile object is moving, and a controller configured to determine a patrol plan for each of a plurality of regions on the basis of said information acquired by said acquisitioner of some mobile objects among said plurality of mobile objects that have moved in the same region, and create an operation command according to the patrol plan for each region determined by said controller.

The plurality of mobile objects acquire information about their surroundings by the acquisitioner while moving. The information includes information relating to prevention of crimes or information relating to the move of the mobile objects that enables an improvement in the effect of crime prevention activities if the mobile objects are moved on the basis of that information. Examples of such information include information about the number of people, information about illuminance, and information about road width. Such information may be, for example, information obtained by analyzing a captured image or information acquired through sensing by a sensor. A plurality of mobile objects acquire information in a plurality of regions. It is possible to know the present circumstances in the respective regions by collecting information thus acquired. Patrol plans suitable for the present circumstances in the respective regions are determined on the basis of the information acquired by the mobile objects in the respective regions. Thurs, patrol can be performed in a manner suitable for the present circumstances in the respective regions. In this way, crime prevention activities using mobile objects can be performed efficiently. The operation command creation part creates operation commands according to the patrol plans. The mobile objects are caused to patrol along designated patrol routes on the basis of the operation commands. The region mentioned above is defined as a zone to which the same patrol plan is to be applied. The regions do not necessarily agree with administrative divisions. For example, different roads may be set as different regions. Each mobile object may patrol one region or a plurality of regions. Patrolling based on the present circumstances in each region enables efficient crime prevent activities using mobile objects.

Said acquisitioner may acquire the number of people as said information, and said controller may determine said patrol plan in such a way as to make the frequency of patrol by said mobile object(s) higher in regions in which the number of people is small than in regions in which the number of people is large.

Regions in which there are a large number of people are advantageous from a crime prevention viewpoint only because of the largeness in the number of people, because the public eye potentially prevents crimes from being committed in such regions. Regions in which the number of people is small do not have such advantages. Determining the patrol plan in such a way as to make the frequency of patrol by mobile objects higher in regions in which the number of people is small can improve the effect of crime prevention activities. On the other hand, determining the patrol plan in such a way as to make the frequency of patrol by mobile objects lower in regions in which the number of people is large can prevent mobile objects from patrolling more frequently than necessary. Thus, crime prevention activities using mobile objects can be performed efficiently. The frequency of patrol may be defined as the number of mobile objects that pass through a specific point in each region per unit time. In the case where the sizes of regions are different, the number of people may be construed as the number of people per unit area. The frequency of patrol can be increased by increasing the times of patrol by the same mobile object or increasing the number of mobile objects employed for patrol. Increasing the number of mobile objects employed for patrol in a region makes the frequency of patrol by mobile objects in that region higher.

Thus, said acquisitioner may acquire the number of people as said information, and said controller may determine said patrol plan in such a way as to make the number of said mobile objects employed for patrol larger in regions in which the number of people is small than in regions in which the number of people is large. The patrol plan that makes the number of mobile objects employed for patrol larger in regions in which the number of people is small can improve the effect of crime prevention activities.

Said acquisitioner may acquire an illuminance as said information, and said controller may determine said patrol plan in such a way as to make the frequency of patrol by said mobile object higher in regions in which the illuminance is low than in regions in which the illuminance is high.

Regions in which the illuminance is high (i.e. bright regions) have advantages in terms of crime prevention over regions in which the illuminance is low (i.e. dark regions). Determining the patrol plan in such a way as to make the frequency of patrol by mobile objects higher in regions in which the illuminance is low can improve the effect of crime prevention activities. On the other hand, determining the patrol plan in such a way as to make the frequency of patrol by mobile objects lower in regions in which the illuminance is high can prevent mobile objects from patrolling more frequently than necessary. Thus, crime prevention activities using mobile objects can be performed efficiently. The illuminance may be the average illuminance in each region.

Said acquisitioner may acquire an illuminance as said information, and said controller may determine said patrol plan in such a way as to make the number of said mobile objects employed for patrol larger in regions in which the illuminance is low than in regions in which the illuminance is high. Determining the patrol plan in such a way as to make the number of mobile objects employed for patrol larger in regions in which the illuminance is low can improve the effect of crime prevention activities.

Said mobile object may be equipped with a light that illuminates the surroundings. In that case, said acquisitioner may acquire an illuminance as said information, and said controller may determine said patrol plan in such a way as to make the illumination by said light brighter in regions in which the illuminance is low than in regions in which the illuminance is high.

Determining the patrol plan in such a way as to make the illumination by the light brighter in regions .in which the illuminance is low can improve the effect of crime prevention activities. On the other hand, the illumination by the light can be prevented from becoming unnecessarily bright in regions in which the illuminance is high. Thus, crime prevention activities using mobile objects can be performed efficiently. Making the illumination by the light brighter includes increasing the luminous intensity of the light or increasing the number of lights that, are turned on.

Said plurality of mobile objects may include mobile objects having different sizes. In that case, said acquisitioner may acquire a road width as said information, and said controller may determine said patrol plan in such a way as to employ smaller mobile objects for patrol in regions in which the road width is small than in regions in which the road width is large.

Employing smaller mobile objects for patrol in regions in which the road width is small enables the patrol to be carried out smoothly. Moreover, this allows mobile objects to patrol roads with smaller road widths, improving the effect of crime prevention activities. The road width mentioned above may be the average road width in each region or the smallest road width in each region.

Said acquisitioner may comprise a camera that captures an image of the surroundings of said mobile object. Information about the surrounding of the mobile object can be acquired using an image captured by the camera. Moreover, it is possible to survey the surroundings of the mobile object using an image captured by the camera, enabling a further improvement in the effect of crime prevention activities.

According to another aspect of the present disclosure, there is provided an autonomous driving method for a plurality of mobile objects that move autonomously in a plurality of regions on the basis of an operation command, comprising the steps of acquiring by said plurality of mobile objects information about their respective surroundings, determining a patrol plan for each of the plurality of regions that is suitable for each region on the basis of said information acquired by some mobile objects among said plurality of mobile objects that have moved in the same region, and creating an operation command according to said patrol plan.

The present disclosure enables crime prevention activities using mobile objects to be performed efficiently.

### BRIEF DESCRIPTION OF THE DRAWINGS

FIG. 1 is a diagram showing the general configuration of an autonomous driving system.

FIG. 2 is a block diagram showing an exemplary configuration of the autonomous driving system shown in FIG. 1.

FIG. 3 is a diagram illustrating the operation of the autonomous driving system.

FIG. 4 is a block diagram showing an exemplary configuration of an autonomous driving system according to a second embodiment.

FIG. 5 is a block diagram showing an exemplary configuration of an autonomous driving system according to a third embodiment.

### DETAILED DESCRIPTION

In the following, specific embodiments of the present disclosure will be described with reference to the drawings The dimensions, materials, shapes, relative arrangements, and other features of the components that will be described in connection with the embodiments are not intended to limit the technical scope of the present disclosure only to them, unless otherwise stated. It should be understood that the features of the embodiments described below may be employed in any feasible combination.

### First Embodiment

### <Outline of the System>

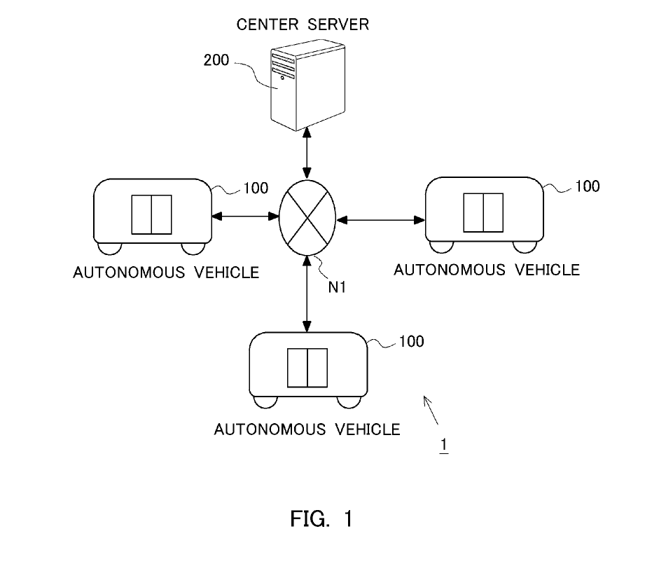

The outline of an autonomous driving system 1 according to the first embodiment will be described with reference to FIG. 1. FIG. 1 shows the general configuration of the autonomous driving system 1. The autonomous driving system 1 according to the first embodiment includes a plurality of autonomous vehicles 100 that can run autonomously according to given operation commands and a center server 200 that issues the operation commands. The autonomous vehicles 100 will also be simply referred to as vehicles 100 hereinafter. The vehicles 100 and the center server 200 are connected with each other by a network N1. While FIG. 1 shows an autonomous driving system 1 including three vehicles 100 for an illustrative purpose, the number of the vehicles 100 may be more than three. The vehicle 100 is one that patrols a road along a predetermined patrol route for the purpose of preventing crimes.

The center server 200 creates operation commands for the respective vehicles 100 and sends the operation commands to the respective vehicles 100. Each vehicle 100 that has received the operation command patrols a road along a predetermined patrol route based on the operation command. The respective patrol routes of the vehicles 100 may be different from each other. When patrolling the road along the predetermined patrol route, each vehicle 100 acquires information about the road and/or information about the surroundings of the road. The information acquired by the vehicle 100 in this way will be hereinafter referred to as “surroundings information”. The surroundings information includes information relevant to passage of the vehicle 100, which includes information about the road width, information about the brightness of lighting in the night, and information about the number of walkers, and information relevant to the prevention of crimes. The surroundings information acquired by each vehicle 100 is sent to the center server 200. After receiving surroundings information in certain regions, the center server 200 creates operation commands suited to the respective regions and sends them to the respective vehicles 100. For example, for a region in which the road width is small, operation commands are created in such a way as to employ small-sized vehicle(s) for patrol in that region. For a region in which the number of walkers (or people) is small, operation commands are created in such a way as to make the number of vehicles 100 patrolling that region greater than that in other regions or to make the frequency of patrol in that region higher than that in other regions. For a region in which lightings in the night are few, operation commands are created in such a way as to make the number of vehicles 100 patrolling that region greater than that in other regions, to make the frequency of patrol in that region higher than that in other regions, or to cause vehicles 100 to illuminate their surroundings by their light in that region. Each autonomous vehicle 100 having received an operation command creates an operation plan according to the operation command and performs a patrol operation according to that operation plan. In this embodiment, we will describe a case where the number of people is acquired as the surroundings information and vehicles 100 are caused to perform a patrol operation on the basis of that number of people.

### <System Configuration>

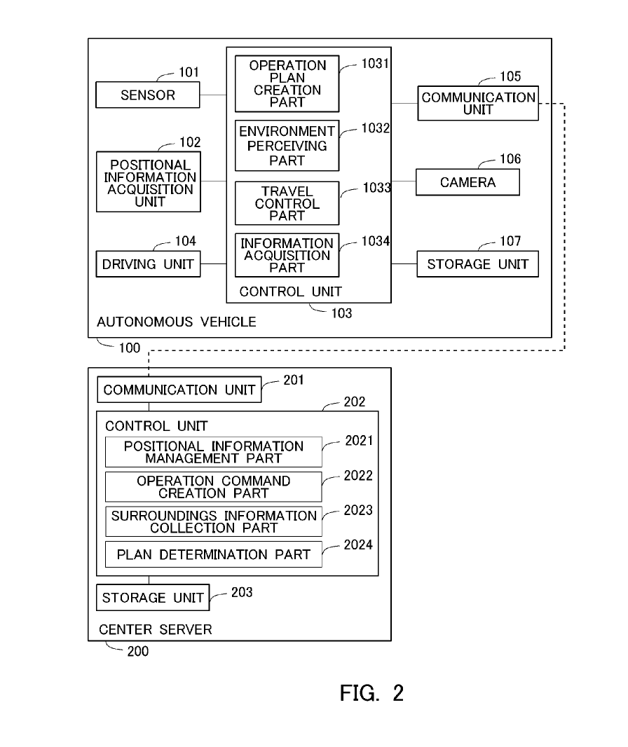

Elements of the system will be described specifically. FIG. 2 is a block diagram showing an exemplary configuration of the autonomous driving system 1 shown in FIG. 1. While FIG. 2 shows one vehicle 100 for an illustrative purpose, the system actually includes a plurality of vehicles 100.

The vehicle 100 travels according to an operation command received from the center server 200. Specifically, the vehicle 100 creates a travel route on the basis of an operation command received through wireless communication and travels on the road in an appropriate manner while sensing its environment. The vehicle 100 includes a sensor 101, a positional information acquisition unit 102, a control unit 103, a driving unit 104, a communication unit 105, a camera 106, and a storage unit 107. The vehicle 100 operates by electrical power supplied by a battery, which is not shown in the drawings. The vehicle 100 corresponds to the mobile object according to the present disclosure.

The sensor 101 is means for sensing the environment of the vehicle, which typically includes a stereo camera, a laser scanner, a LIDAR, a radar, or the like. Data acquired by the sensor 101 is sent to the control unit 103. The positional information acquisition unit 102 is means for acquiring the current position of the vehicle, which typically includes a GPS receiver. Information acquired by the positional information acquisition unit 102 is sent to the control unit 103.

The control unit 103 is a computer that controls the vehicle 100 on the basis of the information acquired through the sensor 101. The control unit 103 is, for example, a microcomputer. The control unit 103 includes as functional modules an operation plan creation part 1031, an environment perceiving part 1032, a travel control part 1033, and an information acquisition part 1034. These functional modules may be implemented by executing programs stored in storage means, such as a read only memory (ROM), by a central processing unit (CPU), neither of which is shown in the drawings.

The operation plan creation part 1031 receives an operation command from the center server 200 and creates an operation plan of the vehicle. In this embodiment, the operation plan is data that specifies a route along which the vehicle 100 is to travel and task(s) to be done by the vehicle 100 in a part or the entirety of that route. Examples of data included in the operation plan are as follows.

(1) Data that Specifies a Route Along Which the Vehicle is to Travel By a Set of Road Links

The route along which the vehicle is to travel may be created automatically according to an operation command with reference to map data stored in storage means. Alternatively, the route may be created using an external service. Still alternatively, the route along which the vehicle is to travel may be provided by the server apparatus. In other words, the route of travel may be specified by the operation command. Still alternatively, the route along which the vehicle is to travel may be selected from a plurality of routes stored in storage means (not shown) by the operation plan creation part 1031 according to an operation command.

### (2) Data Specifying Task(S) to be Done By the Vehicle

Examples of the tasks to be done by the vehicle include, but are not limited to, acquiring surroundings information. The operation plan created by the operation plan creation part 1031 is sent to the travel control part 1033, which will be described later.

The environment perceiving part 1032 perceives the environment around the vehicle using the data acquired by the sensor 101. What is perceived includes, but is not limited to, the number and the position of lanes, the number and the position of other vehicles present around the vehicle, the number and the position of obstacles (e.g. pedestrians, bicycles, structures, and buildings) present around the vehicle, the structure of the road, and road signs. What is perceived may include anything that is useful for autonomous traveling. The environment perceiving part 1032 may track perceived object(s). For example, the environment perceiving part 1032 may calculate the relative speed of the object from the difference between the coordinates of the object determined in a previous step and the current coordinates of the object. The data relating to the environment acquired by the environment perceiving part 1032 is sent to the travel control part 1033, which will be described below. This data will be hereinafter referred to as “environment data”.

The travel control part 1033 controls the traveling of the vehicle on the basis of the operation plan created by the operation plan creation part 1031, the environment data acquired by the environment perceiving part 1032, and the positional information of the vehicle acquired by the positional information acquisition unit 102. For example, the travel control part 1033 causes the vehicle to travel along a certain route in such a way that obstacles will not enter a specific safety zone around the vehicle. A known autonomous driving method may be employed to drive the vehicle. The travel control part 1033 sends the positional information of the vehicle acquired by the positional information acquisition unit 102 to the center server 200 through the communication unit 105. In consequence, the center server 200 knows the current position of the vehicles 100.

The information acquisition part 1034 acquires surroundings information. The information acquisition part 1034 according to this embodiment acquires the surroundings information by counting the number of people by analysis of image(s) captured by the camera 106. The image analysis may be carried out by a known method. While in this embodiment, the number of people is counted using image(s) captured by the camera 106, the number of people may be counted by the sensor 101. The information acquisition part 1034 stores the counted number of people in the storage unit 107 in association with the positional information acquired by the positional information acquisition unit 102 or sends it to the center server 200. The camera 106 functions as the acquisitioner according to the present disclosure.

The driving unit 104 is means for driving the vehicle 100 according to a command created by the travel control part 1033. The driving unit 104 includes, for example, a motor and inverter for driving wheels, a brake, and a steering system. The communication unit 105 serves as communication means for connecting the vehicle 100 to the network HI. In this embodiment, the communication unit 105 can communicate with other devices (e.g. the center server 200) via the network using a mobile communication service based on e.g. 3G or LTE.

The camera 106 is provided on the body of the vehicle 100 to capture images of the surroundings of the vehicle 100. The camera 106 captures images using an image sensor such as a charge-coupled device (CCD) image sensor or a complementary metal oxide semiconductor (CMOS) image sensor Images captured by the camera 106 may be either still images or moving images. The vehicle 100 may have a plurality of cameras 106 provided on different portions of the vehicle body. For example, cameras may be provided on the front, rear, and right and left sides of the vehicle body. The storage unit 107 is means for storing information, which includes a storage medium such as a RAM, a magnetic disc, or a flash memory. Information stored in the storage unit 107 includes, for example, map data and surroundings information acquired by the information acquisition part 1034.

Now, the center server 200 will be described. The center server 200 is an apparatus configured to manage the position of the running vehicles 100 and to send operation commands to the vehicles 100. The center server 200 creates operation commands for vehicles 100 on the basis of surroundings information sent from the vehicles 100 and sends the operation commands to the vehicles 100.

The center server 200 includes a communication unit 201, a control unit (controller) 202, and a storage unit 203. The communication unit 201 is a communication interface, similar to the above-described communication unit 105 of the vehicle 100, for communication with the vehicles 100 via the network N1. The control unit 202 is means for performing overall control of the center server 200. The control unit 202 is constituted by, for example, a CPU. The control unit 202 includes as functional modules a positional information management part 2021, an operation command creation part 2022, a surroundings information collection part 2023, and a plan determination part 2024. These functional modules may be implemented by executing programs stored in storage means, such as a read only memory (ROM), by the CPU, neither of which is shown in the drawings.

The positional information management part 2021 collects and manages positional information sent from the vehicles 100 under its management. Specifically, the positional information management part 2021 receives positional information from the vehicles 100 at predetermined intervals and stores it in association with the date and time in the storage unit 203, which will be described later. The operation command creation part 2022 creates operation commands for the vehicles 100. Each operation command includes data specifying a route along which a vehicle 100 is to travel and data specifying task(s) to be done by the vehicle 100. The surroundings information collection part 2023 collects surroundings information sent from vehicles 100 and stores the collected information in the storage unit 203. The surroundings information stored in the storage unit 203 by the surroundings information collection part 2023 is sorted by regions using the positional information of the vehicles 100. In this embodiment, specifically, the number of people in each of the regions is stored in the storage unit 203.

The plan determination part 2024 determines a plan of operation commands for each of the regions on the basis of the surroundings information collected by the surroundings information collection part 2023. This plan will also be referred to as “patrol plan” hereinafter. The patrol plan is determined in such a way that the frequency of patrol by vehicles 100 is made higher in regions in which the number of people is relatively small than in regions in which the number of people is relatively large. For example, the number of patrolling vehicles 100 may be made larger in regions in which the number of people is relatively small than in regions in which the number of people is relatively large. Each region is defined in advance as a zone to which the same patrol plan is applied. The number of people may be either the raw value counted by the vehicles 100 or a value calculated as the number of people per unit area in each region. The patrol plan thus determined is sent to the operation command creation part 2022, and the operation command creation part 2022 creates operation commands according to the patrol plan. The operation command creation part 2022 creates operation commands by executing a certain program for creating operation commands according to the patrol plan. The storage unit 203 is means for storing information, which is constituted by a storage medium such as a RAM, a magnetic disc, or a flash memory.

### <Operation of the System>

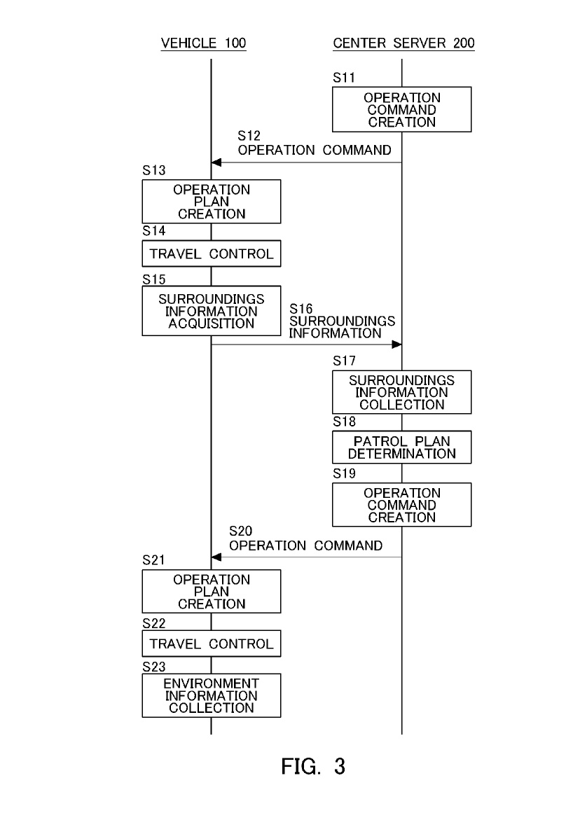

The operation of the autonomous driving system 1 according to the first embodiment will be described in the following with reference to FIG. 3. In the process shown in FIG. 3, the operation command creation part 2022 of the center server 200 creates operation commands for the respective vehicles 100 (processing of S11). In the first round of the operation, operation commands are created in such a way as to cause the vehicles 100 to travel along respective designated patrol routes and captures images by the camera 106 so as to enable the information acquisition part 1034 to acquire information. Such operation commands are sent to the respective vehicles 100 through the communication unit 201 of the center server 200 (processing of S12). The operation plan creation part 1031 of each vehicle 100 that has received the operation command creates an operation plan based on the patrol route specified in the operation command (processing of S13). Then, the travel control part 1033 performs travel control according to this operation plan (processing of S14). Specifically, the travel control part 1033 controls the driving unit 104 to cause the vehicle 100 to travel along the designated patrol route. Alternatively, the operation plan may be created by the center server 200 and sent to the vehicle 100 from the center server 200. While the vehicle 100 travels along the designated patrol route, the information acquisition part 1034 acquires surroundings information using the camera 106 (processing of S15). The information acquisition part 1034 stores the surroundings information thus acquired in the storage unit 107 in association with the positional information acquired by the positional information acquisition unit 102. The information acquisition part 1034 sends the surroundings information to the center server 200 through the communication unit 105 at an appropriate time (processing of S16).

After the center server 200 receives the surroundings information from the vehicles 100, the surroundings information collection part 2023 of the center server 200 collects surroundings information from the vehicles 100 that have traveled the same region with reference to the positional information of the vehicles 100 and stores the surroundings information in the storage unit 203 on a region-by-region basis (in other words, in such a way as to sort the surrounding information by regions) (processing of S17). After a sufficient amount of surroundings information that is large enough to determine a patrol plan is collected, the plan determination part 2024 accesses the data stored in the storage unit 203 on a region-by-region basis to determine patrol plans according to the surroundings information of the respective regions (processing of S18). For example, the patrol plans for the respective regions are determined in such a way as to make the frequency of patrol by vehicles 100 higher or to make the number of patrolling vehicles 100 larger in regions in which the number of people is relatively small than in regions in which the number of people is relatively large.

The operation command creation part 2022 creates operation commands for the respective vehicles 100 according to the patrol plan sent from the plan determination part 2024 (processing of 319). For example, the operation command creation part 2022 may create such operation commands for some vehicles 100 that cause them to move from a region in which the number of people is large to a region in which the number of people is small. The operation commands are sent to the respective vehicles 100 through the communication unit 201 of the center server 200 (processing of S20). The aforementioned operation commands are created in such a way as to cause the information acquisition part 1034 to acquire information by image-capturing by the camera 106. The processing of S21 to S23 is the same as the processing of S13 to S15 described above. The processing of S13 to S20 is executed repeatedly at predetermined intervals. Thus, in every round of the processing, a patrol plan suitable for the circumstances in each region at that time can be created, and patrol by the vehicles 100 can be performed according to that plan.

In the system according to the first embodiment, images captured by the camera 106 of the vehicle 100 may be used for the purpose of preventing crimes. For example, the information acquisition part 1034 may acquire an image of a person using the camera 106 and send the image to the center server 200 through the communication unit 105. Then, the control unit 202 of the center server 200 may judge whether or not the person appearing in the image is a person without problems from a crime prevention viewpoint. This judgement may be conducted by comparing the person appearing in the image with data of persons having a problem (e.g. wanted criminals) from a crime prevention viewpoint stored in the storage unit 203. This comparison may be carried out using known technologies. Detecting a person having a problem from a crime prevention viewpoint in this way helps prevention of crimes.

In this embodiment and the embodiments that will be described in the following, some or all of the functions of the center server 200 may be provided by a vehicle 100, and some of the functions of a vehicle 100 may be provided by the center server 200. For example, the vehicles 100 may include a vehicle that creates operation commands, a vehicle that collects surroundings information from other vehicles, and/or a vehicle that determines a patrol plan.

As above, the system according to this embodiment causes vehicles 100 to operate according to the number of people in each region. Thus, crime prevention activities using mobile objects can be performed efficiently.

### Second Embodiment

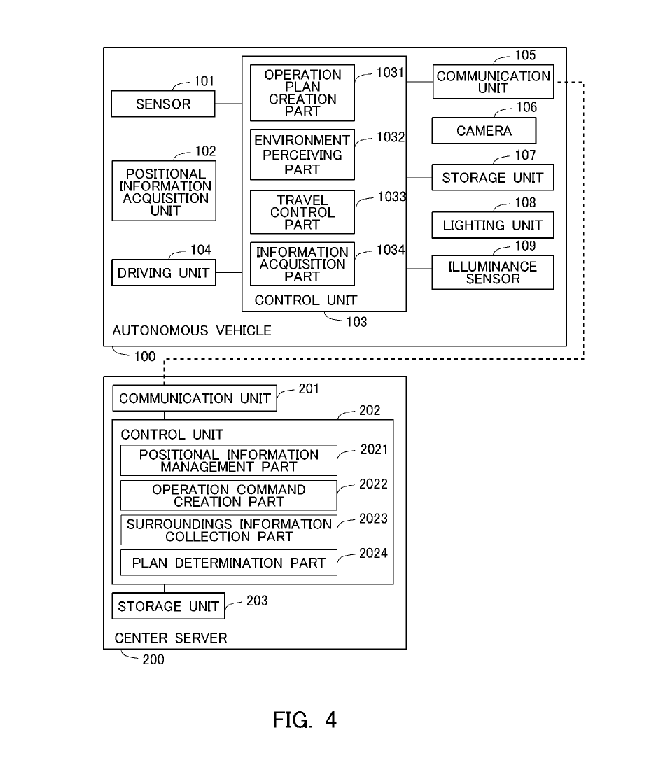

In the system according to the second embodiment, the vehicles 100 are equipped with a lighting unit (light) 108, and a patrol plan is determined in such a way as to cause the lighting unit 108 of the vehicles 100 to illuminate surroundings more brightly in regions that are dark at night. FIG. 4 is a block diagram showing an exemplary configuration of an autonomous driving system 1 according to the second embodiment. While FIG. 4 shows only one vehicle 100 for an illustrative purpose, the autonomous driving system 1 according to the second embodiment actually includes a plurality of vehicles 100. In the following, features of the autonomous driving system 1 that are different from the system according to the first embodiment will be mainly described. The vehicle 100 is equipped with the lighting unit 108 that illuminates the surroundings of the vehicle 100 and an illuminance sensor 109 that measures the outside illuminance. The lighting unit 108 is typically a lighting device including an illumination lamp. However, the lighting unit 108 is not limited to this, but anything that can illuminate the surroundings of the vehicle 100 may be employed as the lighting unit 108. For example, a liquid crystal display, an organic electro-luminescence display, or a plasma display may be employed as the lighting unit 108. The information acquisition part 1034 according to the second embodiment acquires the surroundings information by measuring the illuminance using the illuminance sensor 109. While the illuminance outside the vehicle 100 is measured by the illuminance sensor 109 in the second embodiment, the outside illuminance may be determined by analyzing an image captured by the camera 106. The surroundings information thus acquired is sent to the center server 200 with positional information. The camera 106 or the illuminance sensor 109 functions as the aquisitioner according to the present disclosure.

In the system according to the second embodiment, the surroundings information collection part 2023 collects illuminance data in each region and stores the illuminance data in the storage unit 203 on a region-by-region basis using the positional information of the vehicles 100. The illuminance may be the average illuminance in each region. The plan determination part 2024 determines a patrol plan for each region on the basis of the illuminance in each region collected by the surroundings information collection part 2023. The patrol plan may be determined, for example, in such a way as to make the luminous intensity of the lighting unit 108 higher in regions in which the illuminance is relatively low than in regions in which the illuminance is relatively high or to turn on the lighting unit 108 in regions in which the illuminance is lower than a threshold and not turn on in regions in which the illuminance is higher than the threshold. In cases where the vehicle 100 is equipped with a plurality of lighting units 108, the patrol plan may be determined in such a way as to change the number of lighting units 108 to be turned on according to the illuminance in the regions. The patrol plan thus determined is sent to the operation command creation part 2022, and the operation command creation part 2022 creates operation commands according to the patrol plan. The operation command creation part 2022 creates operation commands by executing a certain program for creating operation commands according to the patrol plan.

The operation of the autonomous driving system 1 according to the second embodiment is similar to the operation of the system according to the first embodiment, shown in FIG. 3. Specifically, in the processing of S15 in FIG. 3, the information acquisition part 1034 acquires the surroundings information (namely, information about the surroundings of the vehicle 100) using the illuminance sensor 109, while the vehicle 100 is travelling along a designated patrol route. Each vehicle 100 sends the surroundings information to the center server 200. Then in the processing of S17, the illuminance data is stored in the storage unit 203 on a region-by-region basis. In the processing of S18, the plan determination part 2024 determines a patrol plan for each of the regions, for example, in such a way as to make the luminous intensity of the lighting unit 108 higher in regions in which the illuminance is relatively low than in regions in which the illuminance is relatively high.

In the above-described case, the patrol plan is determined in such a way as to make the luminous intensity of the lighting unit 108 high in the regions in which the detected illuminance is low. Alternatively, the patrol plan may be determined in such a way as to make the frequency of patrol by vehicles 100 higher in regions in which the illuminance is relatively low than in regions in which the illuminance is relatively high. In that case, the number of vehicles 100 employed for patrol may be made larger in regions in which the illuminance is relatively low than in regions in which the illuminance is relatively high. As above, in regions in which the illuminance is low, the frequency of patrol by vehicles 100 or the number of vehicles 100 may be increased to improve crime prevention activities. Thus, regions in which the number of people is small and regions in which the number of people is large mentioned in the first embodiment are replaced respectively by regions in which the illuminance is low and regions in which the illuminance is high.

As above, the system according to this embodiment causes vehicles 100 to operate according to the illuminance in each region. Thus, crime prevention activities using mobile objects can be performed efficiently.

### Third Embodiment

The autonomous driving system 1 according to the third embodiment includes vehicles 100 having different sizes, and determines patrol plans in such a way that smaller vehicles 100 are employed for patrol in regions in which the road width is relatively small than in regions in which the road width is relatively large. The vehicles 100 in the system according to the third embodiment include at least two types of vehicles 100 that differ in the width and/or length. Vehicles 100 having a shorter width and/or length may be employed for roads with shorter widths. The road width may be measured by the sensor 101 shown in FIG. 2 or 4 or determined by analyzing image(s) captured by the camera 106. The information acquisition part 1034 sends the road width data to the center server 200 through the communication unit 105. Data about the size of each vehicle 100 or data about the road width corresponding to each vehicle 100 are stored in the storage unit 203 of the center server 200. The sensor 101 or the camera 106 functions as the acquisitioner according to the present disclosure.

According to the third embodiment, the surroundings information collection part 2023 collects road width data in each region and stores the road width data in the storage unit 203 on a region-by-region basis using the positional information of the vehicles 100. The average road width in each region may be calculated, and the average value may be stored in the storage unit 203 on a region-by-region basis. The plan determination part 2024 determines a patrol plan for each region on the basis of the road width in each region collected by the surroundings information collection part 2023. For example, smaller vehicles 100 are employed in regions in which the road width is relatively small than in regions in which the road width is relatively large. The patrol plan thus determined is sent to the operation command creation part 2022, and the operation command creation part 2022 creates operation commands according to the patrol plan. The operation command creation part 2022 creates operation commands by executing a certain program for creating operation commands according to the patrol plan.

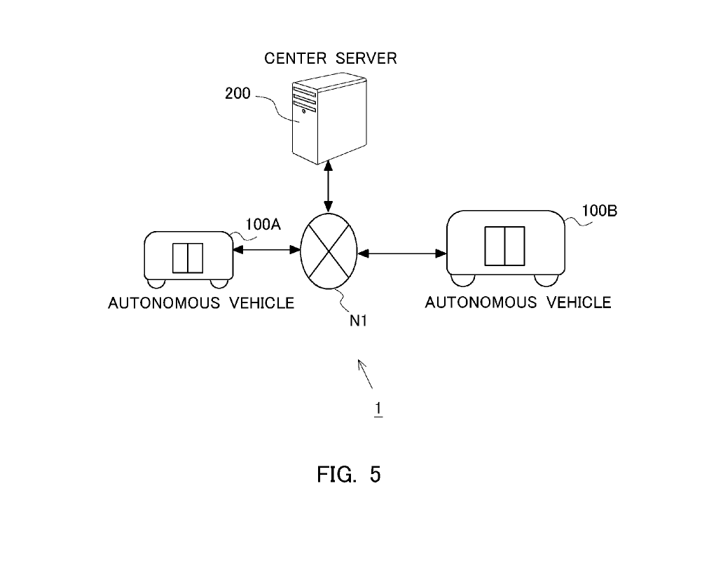

FIG. 5 is a diagram showing the general configuration of the autonomous driving system 1 including small-sized vehicles 100A and large-sized vehicles 100B. The length, width, and height of the small-sized vehicle 100A are smaller than these of the large-sized vehicle 100B. In cases where the system includes two types of vehicles 100 having different sizes as above, small-sized vehicles 100A may be employed for patrol in regions in which the road width is smaller than a threshold, and large-sized vehicles 100B may be employed for patrol in regions in which the road width is larger than the threshold. The threshold is set according to the width of roads that the large-sized vehicles 100B can run.

The operation of the autonomous driving system 1 according to the third embodiment is similar to the operation of the system according to the first embodiment shown in FIG. 3. Specifically, in the processing of S15 in FIG. 3, the information acquisition part 1034 acquires the surroundings information (namely, information about the surroundings of the vehicle 100) using the sensor 101 or the camera 106, while the vehicle 100 is travelling along a designated patrol route. Each vehicle 100 sends the surroundings information to the center server 200. Then in the processing of S17, the road width data is stored in the storage unit 203 on a region-by-region basis. In the processing of S18, the plan determination part 2024 determines a patrol plan for each of the regions, for example, in such a way as to employ smaller vehicles 100 in regions in which the road width is small than in regions in which the road width is large. In the processing of S19, the operation command creation part 2022 creates operation commands for vehicles 100 in such a way that vehicles 100 having suitable sizes are dispatched to respective regions.

As above, even in regions in which the road width is small, patrol can be performed smoothly by employing vehicles 100 having a smaller size. Thus, the system according to the third embodiment can also perform crime prevention activities using mobile objects efficiently.

What is claimed is:

1. An autonomous driving system including a plurality of mobile objects that perform a patrol autonomously on the basis of an operation command, comprising:
an acquisitioner provided in each of said plurality of mobile objects and configured to acquire information about surroundings of said mobile object when said mobile object is moving; and
a controller configured to:
determine a patrol plan for each of a plurality of regions on the basis of said information acquired by said acquisitioner of some mobile objects among said plurality of mobile objects that have moved in the same region; and
create an operation command according to the patrol plan for each region determined by said controller.

2. An autonomous driving system according to claim 1, wherein said acquisitioner is further configured to acquire the number of people as said information, and said controller is further configured to determine said patrol plan in such a way as to make the frequency of patrol by said mobile object higher in regions in which the number of people is small than in regions in which the number of people is large.

3. An autonomous driving system according to claim 1, wherein said acquisitioner is further configured to acquire the number of people as said information, and said controller is further configured to determine said patrol plan in such a way as to make the number of said mobile objects employed for patrol larger in regions in which the number of people is small than in regions in which the number of people is-large.

4. An autonomous driving system according to claim 1, wherein said acquisitioner is further configured to acquire an illuminance as said information, and said controller is further configured to determine said patrol plan in such a way as to make the frequency of patrol by said mobile object higher in regions in which the illuminance is low than in regions in which the illuminance is high.

5. An autonomous driving system according to claim 1, wherein said acquisitioner is further configured to acquire an illuminance as said information, and said controller is further configured to determine said patrol plan in such a way as to make the number of said mobile objects employed for patrol larger in regions in which the illuminance is low than in regions in which the illuminance is high.

6. An autonomous driving system according to claim 1, wherein said mobile object has a light that illuminates the surroundings, said acquisitioner is further configured to acquire an illuminance as said information, and said controller is further configured to determine said patrol plan in such a way as to make the illumination by said light brighter in regions in which the illuminance is low than in regions in which the illuminance is high.

7. An autonomous driving system according to claim 1, wherein said plurality of mobile objects include mobile objects having different sizes, said acquisitioner is further configured to acquire a road width as said information, and said controller is further configured to determine said patrol plan in such a way as to employ smaller mobile objects for patrol in regions in which the road width is small than in regions in which the road width is large.

8. An autonomous driving system according to claim 1, wherein said acquisitioner comprises a camera that captures an image of surroundings of said mobile object.

9. An autonomous driving method for a plurality of mobile objects that move autonomously in a plurality of regions on the basis of an operation command, comprising the steps of:
acquiring by said plurality of mobile objects information about their respective surroundings;
determining a patrol plan for each of the plurality of regions that is suitable for each region on the basis of said information acquired by some mobile objects among said plurality of mobile objects that have moved in the same region; and
creating an operation command according to said patrol plan.
